(19) United States
(12) Patent Application Publication
(10) Pub. No.: US 2008/0073299 A1
(43) Pub. Date: Mar. 27, 2008

(54) OIL FILTER ELEMENT OF WOUND COTTON /PAPER COMPOSITION

(75) Inventors: Le Roy J. Meddock, Oceanside, CA (US); Mark T. Meddock, Oceanside, CA (US)

Correspondence Address: LEWIS, BRISBOIS, BISGAARD & SMITH LLP, 221 NORTH FIGUEROA STREET, SUITE 1200, LOS ANGELES, CA, 90012, US

(73) Assignee: Hepo Filters, Inc., Santa Monica, CA (US)

(21) Appl. No.: 11/858,257

(22) Filed: Sep. 20, 2007

Related U.S. Application Data
(60) Provisional application No. 60/847,179, filed on Sep. 26, 2006.

(51) Int. Cl. B01D 39/18; B01D 29/21; B01D 37/00

(52) U.S. Cl. 210/808; 210/457

(57) ABSTRACT

A filter element comprising a core having a hollow interior, a perforated outer surface, in fluid communication with the hollow interior, an open first end in fluid communication with the hollow interior, and a closed second end. The filter element comprises alternating layers of flat sheet filter material and lengths of cotton/cellulose composition yarn in a plurality of layers over the outer surface of the core, each layer adapted to filter a different size of contaminants, as well as trapping any paper and cotton particles breaking free from the yarn.

This application claims priority from U.S. provisional patent application No. 60/847,179, filed Sep. 26, 2006, which application is incorporated herein by reference.

### FIELD OF THE INVENTION

This invention relates generally to filtration, and more particularly to a method and filter element for filtering contaminants from internal combustion and industrial engine oil.

### BACKGROUND OF THE INVENTION

A typical full flow filter system in an on-highway vehicle allows a flow rate in the range of about ten to twenty gallons per minute. Passing oil at that flow rate through a pleated paper or other conventional filter element filters out particulate matter down to about 40 microns in size, from the engine oil. The filter however often fails to trap smaller particles and remove moisture, and so the oil must be changed more frequently than desired.

Vehicle owners often use an auxiliary bypass filter for additional filtering. A typical bypass filter retrofits to a vehicle engine where it diverts oil through a finer auxiliary filter element at a much slower rate (e.g., ¼ to 1 gallon per minute or less). Passing the oil through the auxiliary filter element helps filter out particles smaller than 40 microns. That improves engine oil life and the life of the engine.

However, bypass filters have had certain problems that needed to be overcome. For example, many existing bypass filter elements are surface filters, in the sense that filtering occurs at just the outer surface of the element where the oil first enters the element. With very fine surface filter elements, particles tend to accumulate at the outer surface, thereby loading the filter element and cutting off the flow of oil through it. As a result, filtering is degraded and the element must be changed more frequently than desired.

In addition, many existing bypass filter elements result in “channeling”, in the sense that the oil passes through the filter element along one or more channels or paths of less resistance. The filter element may initially have such paths of less resistance (a problem in rolled media filters made with cotton/synthetic fibers composition) or develop them over time (a problem of filters packed with cotton/synthetic fibers, sawdust, hulls, and other such media). Oil passing under pressure through the filter element seeks out the channels, and a breach in the surface of the filter element may even allow the oil to flow through the filter without any filtering at all.

Applicants solved the above stated problems by designing a filter element described in our prior U.S. Pat. No. 5,552,065 issued Sep. 3, 1996. This invention is an improvement on the filter element described in that patent. The filter element described in our prior patent comprised a specialty wound, cylindrically-shaped filter element. The filter element had an elongated hollow core on which a length of yarn is wound in a multi-layered winding. The yarn is a composition of cotton and cellulose paper so that it absorbs water without the usual step of heating the oil. In addition, it is wound with an irregular winding pattern, such that layers near the core are adapted to filter particles down to a size of one micron and layers further out from the core are adapted to filter particles down to a size of 5 microns. A preferred embodiment included layers near the outer circumference of the filter element that are adapted to filter particles down to a size of 25 microns.

The petroleum-based or synthetic oil to be filtered passed radially through the multi-layered, winding of the filter element, from the outer circumference of the filter element into the hollow core, and then axially through the hollow core back out of the canister. Different layers of the filter element trapped different size particles, ranging from about 25-40 microns at the outer circumference to about 3-10 microns near the core. The cotton-and-cellulose-paper composition of the yarn absorbs water, which aids to filter the oil more effectively.

### SUMMARY OF THE INVENTION

The improved filter element of this invention comprises a filter element in a canister having an inlet and an outlet. The filter element comprises;
1. A cylindrical cotton/cellulose yarn wound filter element comprising an inner perforated metal cylindrical core, which may optionally, be wrapped with a sheet of non-micron rated, migration barrier material. This material may be a microglass synthetic media, or other common material such as nylon, which prevents pieces of yarn from flowing into the engine. Then, depending upon the desired micron rating for the finished element, a first layer of 0.5-3 microns rated, flat sheet, filter material, the innermost layer, is wrapped around the core, or the migration material if present, with one or more turns, which will provide an absolute 0.5-3 micron surface barrier.
2. A second layer made of cotton/cellulose yarn is helically wound to a nominal rating matching the micron rating to the flat sheet filter material innermost first layer, to a cylindrical depth of about 0.500 inches to about 0.750 inches. The second layer will provide progressive depth filtration to the nominal desired rating of the element.
3. A third layer of 1 to 3 micron rated flat sheet material is then wrapped, with one or more turns around the second layer. The third layer will provide an absolute 1 to 3 micron surface barrier.
4. A fourth layer of helically wound cotton/cellulose yarn wound to a nominal 1 to 4 micron rating, is wound around the third layer and wound to the final cylindrical diameter. This filter element design will provide progressive depth filtration through the outer layer to a nominal 1 to 4 microns.

### “Absolute”, as used to describe filtration efficiency, means a filtration efficiency of 98%, or better, for the given micron size.

### BRIEF DESCRIPTION OF THE DRAWINGS

FIG. 1 is a cross-sectional view showing a filter element constructed according to the invention;

FIG. 2 is a cross-sectional view of the filter element taken on lines 2-2 of FIG. 1.

### DESCRIPTION OF THE PREFERRED EMBODIMENTS

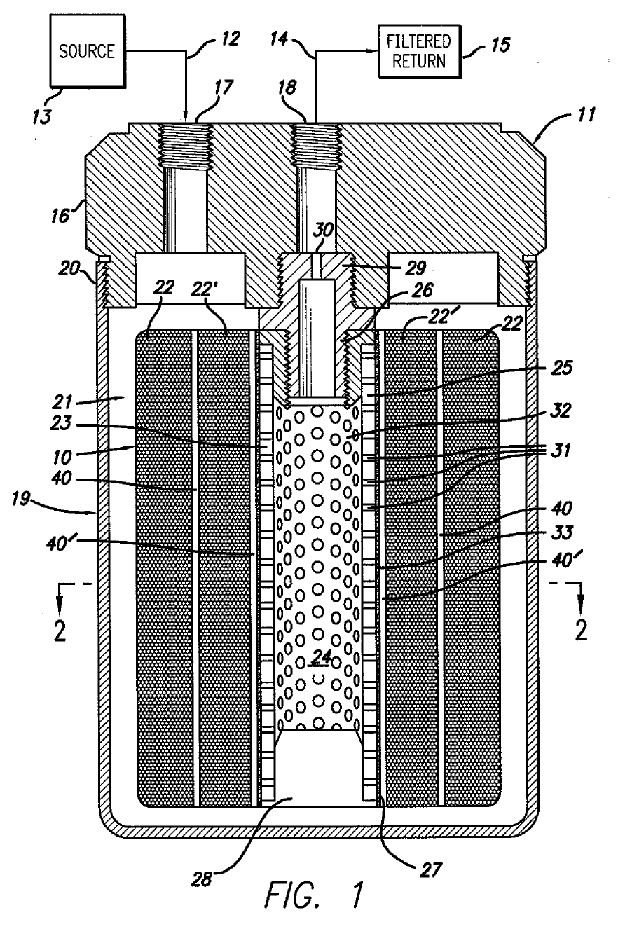

FIG. 1 of the drawings shows a filter element 10 constructed according to the invention. Filter element 10 is mounted in a canister assembly 11 that is connected, as shown diagrammatically in FIG. 1, via a first line 12, to a pressurized source 13 of oil (e.g., an auxiliary oil port on the block of an engine on a truck) and via a second line 14, to a return 15 (e.g., valve cover, oil filler pipe, or oil pan on the engine). Interconnected that way, filter element 10 is used according to the method of the invention to filter oil (e.g., provide additional filtering of the truck engine oil).

Canister assembly 11 may be similar in some respects to known filter element containers used in other cartridge-based filter installations. It includes a cap 16 of metal, or other suitable composition, that mounts by suitable means on an available support structure. Cap 16 may mount under the hood of a truck next to the engine, or any other convenient location, for example. Cap 16 includes an inlet 17 to which line 12 connects by a known type of fitting or other suitable means (the details of which are not shown) and an outlet 18 to which line 14 connects by another fitting or other suitable means (not shown).

Canister assembly 11 also includes an upwardly opening canister 19, of steel or other suitable composition, with a threaded upper lip 20 that screws onto cap 16 and a hollow interior 21 in which filter element 10 fits. The user first mounts the filter element 10 on cap 16, then screws the canister 19 onto cap 16 to complete the installation.

Although the size and shape of components may vary according to the precise installation, the illustrated filter element 10 is a generally cylindrically shaped component, typically having about a four-inch outside diameter and about an eight-inch axial length. Filter element 10 comprises alternating layers of flat sheet, synthetic filter media 40 and layers of yarn 22, wound in a multi-layered winding, on an elongated, cylindrically shaped core 23, composed of steel or other suitably rigid material. Core 23 has a hollow interior 24, a first end 25 into which a first plug 26 is mounted in a force fit, and a second end 27 into which a second plug 28 is mounted in a force fit.

First plug 26 screws onto an adaptor component 29 that screws into cap 16. First plug 26 and adaptor component 29 thereby connect first end 25 and hollow interior 24 of core 23, in fluid communication with outlet 18 of cap 16, through an orifice 30 in adaptor component 29 that restricts the flow rate to a desired range. Meanwhile, second plug 28 closes second end 27 of core 23, and a series of openings 31 in core 23 form a perforated outer surface 32 of core 23, in fluid communication with hollow interior 24 of core 23. Only a few of the openings 31 are shown in FIG. 1 for illustrative convenience.

Oil from source 13 passes through line 12, into inlet 17 in cap 16, at about one to two quarts per minute. From there, the oil passes into interior 21 of canister 19. Next, the oil passes radially through the plurality of layers, subsequently described, of a multi-layered winding of yarn 22, then one or more turns of flat sheet, synthetic filter material 40, a second multi-layered winding of yarn 22′, then another one or more turns of flat sheet, synthetic filter material 40′ and thereafter through an optional sheet of non-micron rated, migration barrier material 33 covering the perforated surface 32 of core 23. Optional migration barrier material 33 forms a cylindrically shaped sleeve over core 23, between the flat sheet synthetic filter material 40 and perforated surface 32, and is capable of passing particles smaller than 40 microns while trapping any cotton and paper particles breaking free from the yarn. Optional migration barrier material 33 may be a microglass synthetic media, or other common material such as nylon, which prevents pieces of yarn from flowing into the engine.

The flat sheet filter material is made of filter material having the capacity to withstand at least 250 degrees F. hot oil and not lose structure or rupture when exposed to water.

After passing through filter paper 33, the oil passes through openings 31, into interior 24 of core 23. Next, the oil passes axially through core 23 towards first plug 26. Then the oil passes through first plug 26, adaptor component 29, outlet 18 in cap 16, through line 14 to return 15. As the oil follows the described path, particles in the oil are trapped in the many layers of yarn wound on core 23.

According to an aspect of the invention, the yarn is composed of a composition of cotton and cellulose paper and is wound with an irregular winding pattern, such that some layers near core 23 trap smaller particles while layers further from core 23 trap larger particles. Using a known type of spinning machine, such as may be used in the textile trade, for example, strands of carded cotton and toilet tissue are spun into about a 150 to about 180 grains per 12 yards length of yarn, preferably about 165 grains to about 170 grains per 12 yards, composed of about 5-25% cellulose paper (preferably about 5-10%). Then, using a known type of precision winding machine such as may be used in the textile trade for winding bobbins, for example, the length of yarn is wound in an irregular winding pattern onto core 23.

Core 23 is mounted on the winding machine and rotated by the machine at a controlled rate while the yarn is fed through a head to core 23 so that it winds onto core 23. Meanwhile, the head is moved back and forth, parallel to the longitudinal axis of core 23. By varying the speed of rotation and the speed of the head, various winding patterns are produced by the winding machine in a manner known by those of ordinary skill in the winding art. That is done in winding yarn 22 on core 23 to form each of the yarn layers, so that the winding pattern is different for various ones of the plurality of yarn layers of filter element 10.

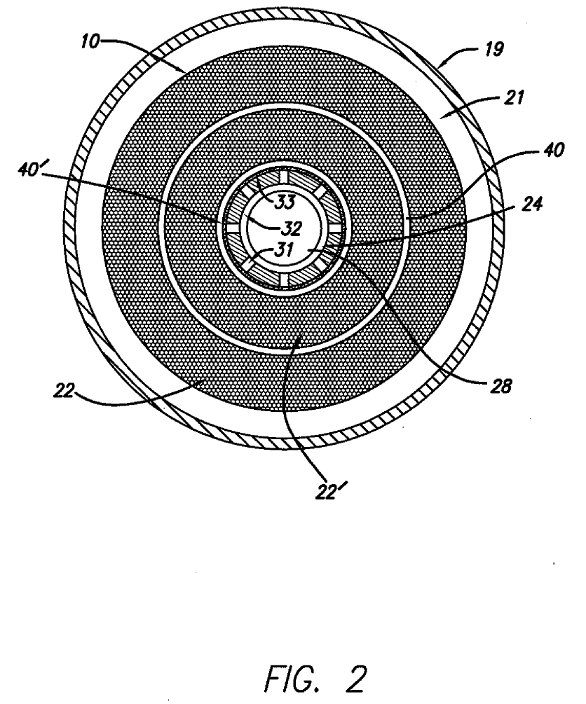

FIG. 2 uses lines to depict four layers 40, 22, 40′ and 22′, of filter element 10. Of those layers, flat sheet filter material layer 40 is radially nearest core 23 while each one of the layers 22, 40′ and 22′ is progressively further out from core 23 than the preceding layer. Layer 22′ is the farthest from core 23 and defines the outer circumference of filter element 10. Optional migration barrier material 33, wrapped around core 23 between layer 22 and core 23, is a synthetic media, such as microglass or other common material such as nylon, which prevents pieces of yarn from flowing into the engine.

Depending upon the desired micron rating for the finished element, a first layer 40 of 0.5-3 microns rated, flat sheet, synthetic filter media, the inner most layer, is wrapped around core 23, or migration material 33 if present, with one or more turns, which will provide an absolute 0.5-3 micron surface barrier.

A second layer 22 of cotton/cellulose yarn is helically wound to a nominal rating matching the micron rating to the innermost layer and to a cylindrical depth of about 0.500 inches to about 0.750 inches. The second layer will provide progressive depth filtration to the nominal desired rating of the element.

A third layer 40′ of 1 to 3 micron rated flat sheet synthetic media is then wrapped, with one or more turns around the second layer. The third layer will provide an absolute 1 to 3 micron surface barrier.

A fourth layer 40′ of helically wound cotton/cellulose yarn wound to a nominal 1 to 4 micron rating, is wound around the third layer and wound to the final cylindrical diameter. This filter element design will provide progressive depth filtration through the outer layer to a nominal 1 to 4 microns.

“Absolute”, as used to describe filtration efficiency, means a filtration efficiency of 98%, or better, for the given micron size.

The yarn layers are wound in an irregular winding pattern such that at least one inward one of the layers disposed near core 23 (e.g., layer 22) has a first winding pattern (a first size weave) adapted to filter particles down to (i.e., no smaller than) a first size (e.g., 0.5 microns). In addition, at least one layer disposed radially further out from core 23 than the inward layer (e.g., layer 40′) has a different second winding pattern (a second size weave) adapted to filter particles down to (i.e., no smaller than) a second size that is larger than the first size (e.g. 4 microns). Wound that way, all the particles filtered from the oil do not collect at or near the outer circumference. They collect at different radial distances from core 23.

From the foregoing description, one of ordinary skill in the art can vary the number, frequency, position, and size of the various weaves to achieve the function described without departing from the inventive concepts disclosed. The table below illustrates how the layers may be sized to achieve various micron rated filtering.

| | Nominal Micron Rating | | | |
|---|---|---|---|---|
| Desired | First Layer | Second | | |
| Element | Innermost | Layer | Third Layer | Fourth Layer |
| Micron Rating | Sheet | Inner Wind | Middle Sheet | Outer Wind |
| 0.5 Micron | 0.5 Micron | Nominal 0.5 | 1 Micron | 2 Micron |
| 1 Micron | 1 Micron | Nominal 1 | 2 Micron | 3 Micron |
| 2 Micron | 2 Micron | Nominal 2 | 3 Micron | 4 Micron |
| 3 Micron | 3 Micron | Nominal 3 | 4 Micron | 5 Micron |

The method proceeds by introducing the oil into the inlet of the canister under pressure at a flow rate in the range of from about one-half to about two quarts per minute. That is done so that the oil passes radially from an outer circumference of the filter element, through the layers of the filter element, and into the hollow core. The method of this invention thereby traps different size particulate matter at different layers of the filter element while absorbing water from the oil. The oil is then discharged from the hollow core back out of the outlet of the canister. When the oil achieves operating temperature of about 200 degrees F. and higher, the water begins to vaporize and is vented from the engine. The flat sheet filter material is made of filter material having the capacity to withstand at least 250 degrees F. hot oil and not lose structure or rupture when exposed to water.

In line with the above, a filter element constructed according to the invention includes a core having a hollow interior, a perforated outer surface in fluid communication with the hollow interior, an open first end in fluid communication with the hollow interior, and a closed second end. The filter element includes cotton/cellulose composition yarn wound in a plurality of layers over the outer surface of the core in an irregular winding pattern such as that described above. The yarn layers are alternated with layers of flat sheet, synthetic filter media material disposed between the yarn layers, having a micron rating the same or similar to the adjacent yarn winding. Each layer of flat sheet filter material, and each layer of yarn, filters particles of a progressively larger size moving further away from the hollow core.

According to still another aspect of the invention, the yarn may be spun using known textile equipment from carded cotton and conventional cellulose paper (e.g., toilet tissue), enabling a single filter element to absorb up to 100 cc of water.

Certain vehicles or equipment, such as construction equipment, typically need a higher flow rate and lower filtration. A transit bus, on the other hand, would require finer filtration. The ability to vary the micron rating in the two flat sheet layers of synthetic filter material, allows the customization of the filter element according to various equipment needs.

Although an exemplary embodiment has been shown and described, one skilled in the art may make changes, modifications and substitutions without necessarily departing from the scope and spirit of the invention.

What is claimed is:

1. A method of filtering oil, comprising:
providing a filter element in a canister having an inlet and an outlet, the filter element having an elongated hollow core with a perforated outer surface;
said filter element comprising a plurality of alternate layers of flat sheet filter material and yarn;
said flat sheet filter material wrapped in one or more turns over the outer surface of the core;
said yarn wound over the outer surface of the flat sheet filter material, such that at least one inward one of the layers disposed near the core has a first winding pattern adapted to filter particles down to a first size and at least one of the layers, disposed radially further out from the core than the at least one inward one of the layers, has a different second winding pattern adapted to filter particles down to a second size that is larger than the first size;
introducing the oil into the inlet of the canister under pressure so that the oil passes radially from an outer circumference of the filter element and through the plurality of layers of the filter element into the hollow core, to thereby trap different size particulate matter at different layers of the filter element; and discharging the oil from the hollow core out of the outlet of the canister.

2. The method of filtering oil of claim 1 in which each layer of flat sheet filter material filters particles of a progressively larger size moving further away from the hollow core.

3. The method of filtering oil of claim 1 in which each layer of yarn is wound in an irregular winding pattern.

4. The method of filtering oil of claim 1 in which the yarn is made of a cotton and cellulose paper composition.

5. The method of filtering oil of claim 1 in which the flat sheet filter material is made of filter material having the capacity to withstand at least 250 degrees F. hot oil and not lose structure or rupture when exposed to water.

6. The method of filtering oil of claim 1 in which the filter element also comprises a sheet of migration barrier material which is wrapped around the perforated outer surface of the hollow core.

7. The method of filtering oil of claim 6 in which the sheet of migration barrier material is made of a microglass synthetic media or nylon.

8. The method of filtering oil of claim 1, in which said yarn has an irregular winding pattern.

9. The method of filtering oil of claim 8, in which at least one of the layers of yarn disposed radially further out from the core than at least one of the layers closer to the core, has a second different winding pattern than the first winding pattern of the layer closer to the core, said second winding pattern being adapted to filter particles down to a size that is larger than the particles filtered by said layer closer to the core.

10. A filter element, comprising:
a core having a hollow interior, a perforated outer surface in fluid communication with the hollow interior, an open first end in fluid communication with the hollow interior, and a closed second end;
a plurality of alternate layers of flat sheet filter material and yarn;
said flat sheet filter material wrapped in one or more turns over the outer surface of the core;
said yarn being wound over the outer surface of said flat sheet filter material, such that at least one inward one of the layers disposed near the core is adapted to filter particles down to a first size and at least one of the layers, disposed radially further out from the core than the at least one inward one of the layers, is adapted to filter particles down to a second size that is larger than the first size.

11. The filter element of claim 10 in which the yarn is wound in a plurality of layers over the perforated outer surface of the core in an irregular winding pattern, each layer having a different winding pattern, such that each of the layers is adapted to filter different size particles.

12. The filter element of claim 10 in which each layer of flat sheet filter material filters particles of a progressively larger size moving further away from the hollow core.

13. The filter element of claim 10 further comprising a layer of migration barrier material disposed between the plurality of layers and the perforated outer surface of the core for trapping any paper and cotton particles breaking free from the yarn;

14. The filter element of claim 10 in which the plurality of layers of the yarn includes at least one inward layer disposed near the core, said at least one inward layer having a first winding pattern adapted to filter particles down to a first size; and at least one outward layer disposed radially further out from the core than the at least one inward layer, said at least one outward layer having a different second winding pattern adapted to filter particles down to a second size that is larger than the first size.

15. The filter element of claim 10, in which the cellulose paper composition of the yarn is in the range of about 5% to about 25% of total yarn composition.

16. The filter element of claim 10 in which the flat sheet filter material is made of filter material having the capacity to withstand at least 250 degrees F. hot oil and not lose structure or rupture when exposed to water.

17. The filter element of claim 14, in which the first size is from about 0.5 to about 3 microns.

18. The filter element of claim 14, in which the second size is from about 1 micron to about 4 microns.

19. The filter element of claim 10, wherein the plurality of layers of the filter element includes at least two yarn layers disposed radially out from the core, each layer having a different winding pattern adapted to filter particles down to progressively larger sizes, the further the layer is from the core.

20. The filter element of claim 10 further comprising a sheet of migration barrier material wrapped around the perforated outer surface of the hollow core.

21. A method of fabricating a filter element for filtering oil, comprising:
providing a core with a hollow interior and a perforated outer surface in fluid communication with the hollow interior;
wrapping flat sheet filter material in one or more turns over the outer surface of the core;
winding a length of yarn comprised of cotton and cellulose paper over the outer surface of the flat sheet filter material in an irregular winding pattern;
wrapping alternating flat sheet filter material and winding yarn in a plurality of additional layers;
such that at least one inward layer of flat sheet filter material and one inward layer of yarn near the core is adapted to filter particles down to a first size and at least one layer of fiat sheet filter material and one layer of yarn, radially further out from the core than the inward layers, is adapted to filter particles down to a second size that is larger than the first size.

22. The method of fabricating a filter element of claim 20, wherein the step of winding a length of yarn includes spinning the length of yarn from cotton and cellulose paper.

23. A method of fabricating a filter element of claim 21, wherein the step of spinning includes spinning the length of yarn from cotton and toilet tissue.
